(19) United States
(12) Patent Application Publication
(10) Pub. No.: US 2007/0174641 A1
(43) Pub. Date: Jul. 26, 2007

(54) Adjusting power supplies for data storage devices

(76) Inventors: Michael J. Cornwell, San Jose, CA (US); Christopher P. Dudte, San Jose, CA (US)

Correspondence Address: FISH & RICHARDSON P.C., PO BOX 1022, MINNEAPOLIS, MN, 55440-1022, US

(21) Appl. No.: 11/339,290

(22) Filed: Jan. 25, 2006

(51) Int. Cl. G06F 1/00

(52) U.S. Cl. 713/300

(57) ABSTRACT

Articles of manufacture and associated methods and systems can be implemented for identifying a condition in which a voltage level being supplied to a data storage device (DSD) may be increased as needed to operate the data storage device. Upon identifying such a condition, the voltage level supplied to the DSD may be increased incrementally. In some implementations, a controller signals a voltage regulator to increment a DSD supply voltage in response to a determination that the present voltage level is insufficient to operate at a desired performance level. The voltage level supplied to a DSD may be adjusted when power is applied to the DSD from an unpowered state, and/or during operation of the DSD. Automatically increasing the voltage supplied to a DSD as needed to support operation may promote high efficiency at low voltages and extended service life at higher voltages.

### TECHNICAL FIELD

Various implementations may relate generally to controlling electrical power being supplied to data storage devices, and particular implementations may relate to methods and systems for adjusting voltages supplied to disc drives or flash memory devices.

### BACKGROUND

As computing devices have increased in capabilities and features, demand for data storage devices has grown. Data storage devices have been used, for example, to store program instructions (i.e., code) that may be executed by processors. Data storage devices have also been used to store other types of data, including audio, image, and/or text information, for example. Recently, systems with data storage devices capable of storing substantial data content (e.g., songs, music videos, etc. . . . ) have become widely available in portable devices.

Such portable devices include data storage devices (DSDs) that have small form factors and are capable of operating from portable power sources, such as batteries. Some DSDs in portable devices may provide non-volatile memory that is capable of retaining data when disconnected from the power source. Portable devices have used various non-volatile data storage devices, such as hard disc drives, EEPROM (electrically erasable programmable read only memory), and flash memory.

Flash memory has become a widely used type of DSD. Flash memory may provide a non-volatile memory in portable electronic devices and consumer applications, for example. Two types of flash memory are NOR flash and NAND flash. NOR flash typically provides the capacity to execute code in place, and is randomly accessible (i.e., like a RAM). NAND flash can typically erase data more quickly, access data in bursts (e.g., 512 byte chunks), and may provide more lifetime erase cycles than comparable NOR flash. NAND flash may generally provide non-volatile storage at a low cost per bit as a high-density file storage medium for consumer devices, such as digital cameras and MP3 players, for example.

Disc drives are another widely used type of DSD. Some disc drives magnetically store digital or analog encoded information on a rotating storage medium (e.g., disc). Some disc drives communicate with a processor or a controller through an industry standard interface, such as an ATA interface.

In a wide array of devices, DSDs draw power from a voltage regulator designed to regulate a supplied voltage to a fixed level. In some applications, the voltage supplied to the DSD may be a convenient value such as 3.3V, 5V, or 12V, for example.

### SUMMARY

Articles of manufacture and associated methods and systems can be implemented for identifying a condition in which a voltage level being supplied to a data storage device (DSD) may be increased as needed to operate the data storage device. Upon identifying such a condition, the voltage level supplied to the DSD may be increased incrementally. In some implementations, a controller signals a voltage regulator to increment a DSD supply voltage in response to a determination that the present voltage level is insufficient to operate at a desired performance level. The voltage level supplied to a DSD may be adjusted when power is applied to the DSD from an unpowered state, and/or during operation of the DSD. Automatically increasing the voltage supplied to a DSD as needed to support operation may promote high efficiency at low voltages and extended service life at higher voltages.

In various implementations, the DSD may include one or more of a flash memory and/or a device with a rotating storage medium, such as a hard disc drive. The controller may be implemented in a processor, and/or operate in cooperation with a processor. In some implementations, the controller may receive access commands from a host processor over an ATA interface and then process those commands using a flash memory or a disc drive. One or more temperature measurements may be used to adjust the voltage supplied to the DSD.

Some implementations may provide one or more advantages. Battery life may be extended for portable power applications. Power consumption may be reduced and/or the useful service life of a DSD may be improved.

The details of one or more implementations of the invention are set forth in the accompanying drawings and the description below. Other features of the invention will be apparent from the description and drawings, and from the claims.

### DESCRIPTION OF DRAWINGS

FIG. 1 is a block diagram showing an example of a system having a flash memory and a disc drive as data storage devices (DSDs).

FIG. 2 is a flow diagram illustrating a method for adjusting a voltage supplied to a DSD when applying power to the DSD from an unpowered state.

FIG. 3 is a flow diagram illustrating a method for adjusting a voltage supplied to a DSD during operation.

Like reference symbols in the various drawings indicate like elements.

### DETAILED DESCRIPTION OF ILLUSTRATIVE EXAMPLES

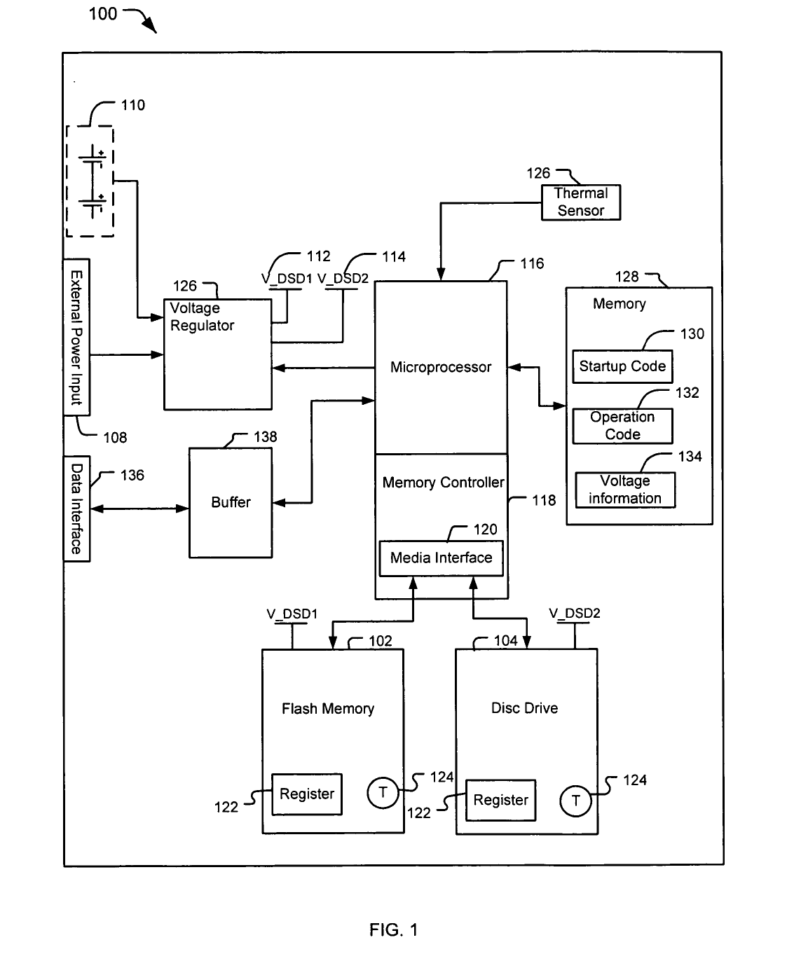

FIG. 1 shows an example of a system 100 capable of storing and retrieving data using flash memory. The system 100 may be, for example, a handheld portable device, such as an MP3 player, cell phone, PDA (portable digital assistant), global positioning system, portable processing device, portable audio/visual recording device, portable video player, or the like. The system 100 includes data storage device (DSD), which in this example includes a flash memory 102 and a disc drive 104. In some implementations, the system 100 can include a flash memory 102 but not a disc drive 104 or a disc drive 104 but not a flash memory 102. The system 100 is capable of using and/or selecting one or more appropriate voltage levels to operate the DSDs 102, 104. In some implementations, the selected voltage level may be adjusted to account for temperature conditions (e.g., ambient temperature, internal temperature of the disc drive, temperature in or around the flash memory 102) in the operating environment. In some implementations, the selected voltage level for the flash memory 102 may be selected dynamically and/or independently of the disc drive 104.

Electrical power of the DSDs 102, 104 may be provided by a voltage regulator 106. The voltage regulator 106 obtains power either from an external power input 108 or from a battery 110. The voltage regulator 118, which may include a linear regulator, a switch-mode DC-to-DC converter (e.g., buck, boost, buck-boost, SEPIC, Cuk, flyback, forward), and/or a low drop-out regulator (not shown), may power the flash memory 102 via a V_DSD1 output 112 and the disc drive 104 via a V_DSD2 output 114.

The system 100 includes a microprocessor 116 and a memory controller 118. The microprocessor 116 may perform read or write operations after selecting a voltage level for the DSD 102, 104. For example, the microprocessor 116 can initiate a read from the flash memory 102 by sending the selected voltage level to the voltage regulator 106 and the read command to the memory controller 118. The memory controller 118 then executes the read command with the DSD being supplied with the selected voltage level. For example, the memory controller 118 maybe a SST55LD019 ATA flash disc controller, available from Silicon Storage Technology, Inc. of Sunnyvale, Calif. In some implementations, the microprocessor 116 and the memory controller 118 may be separate devices (e.g., independent integrated circuits). In other implementations, the microprocessor 116 and the memory controller 118 may be integrated into a single device (e.g., ASIC, microcontroller). In this example, the memory controller 104 includes a media interface 120 to communicate with the DSDs 102, 104.

In this example, each of the DSDs 102, 104 includes a register 122 and a thermal sensor 124. The register 122 may store voltage information, such as a minimum operating voltage, and operating status of each DSD 102, 104. The microprocessor 116 and/or the memory controller 118 may receive information from the register 122. Examples of reporting minimum operating voltages are described in co-pending U.S. patent application to Cornwell et al., assigned serial number ______, entitled “Reporting Flash Memory Voltage Requirements”, which was filed on Jan. 25, 2006, the entire contents of which are incorporated herein by reference. In some implementations, the minimum operating voltage of each DSD 102, 104 may be retrieved to select the operating voltage. For example, during the first commission of the flash memory 102, the microprocessor 116 may retrieve the minimum operating voltage that is stored in the register 122 of the disc drive 104, and then may select the retrieved minimum operating voltage as a default operating voltage for the V_DSD2 output 114. When applying power to the DSDs 102 and/or 104, the microprocessor 116 may instruct the voltage regulator 106 to adjust voltage outputs 112, 114 based on the corresponding retrieved voltage information.

Over their service life, the DSDs 102, 104 may suffer from wear and tear during operation that may introduce operational inefficiencies. For example, the disc drive 104 may have increased friction after the disc drive is used for a period of time. When the friction is higher than a certain threshold, the disc drive 104 may not be operational using a nominal operating voltage, which may be selected, for example, based on the minimum operating voltage stored in the register 122. By increasing the output voltage from the voltage regulator 106, the operational lifetime of the disc drive 104 may be extended. By allowing the voltage to incrementally increase as needed, power savings may be reduced by permitting, in some implementations, use of an operating voltage lower than a nominal voltage.

In some implementations, the system 100 may select voltage levels for read and write commands as follows. The microprocessor 116 may initiate a memory access command to the disc drive 104 when, for example, the system 100 starts up or changes operating mode. The microprocessor 116 may read the register 122 in the disc drive 104 to obtain a minimum operating voltage level for the disc drive 104. The microprocessor 116 may select the minimum operating voltage level and the voltage regulator 106 may apply the selected voltage to the disc drive using the V_DSD2 output 114. After some time, in some implementations, the microprocessor 116 may access the register 112 for the operating status of the disc drive 104. If the disc drive is not operational, the microprocessor 116 may select a higher operating voltage for the disc drive 104.

In addition, the microprocessor 116 may check the maximum acceptable voltage (e.g., maximum rated voltage) to the DSDs 102, 104 before incrementing the operating voltage level. If a higher operation voltage is allowed, then the microprocessor 116 may select a higher operating voltage. Otherwise, an error signal may be generated, indicating that the DSD 102, 104 may be in an error state that may not be resolved by increasing the voltage.

In some implementations, during operation, the microprocessor 116 may update the selected voltage level by checking the status of the disc drive 104. For example, the microcontroller 116 may be configured to check or receive operating status of the disc drive 104 periodically. The microprocessor 116 may update the operating voltage based on the received operating status. For example, the operating status may indicate that, for example, an extended period of operating time is used, or the disc drive 104 is not operational. In such cases, the microprocessor 116 may update the operating voltage accordingly.

In some implementations, the microprocessor may select voltage levels using, at least in part, a predetermined formula that is a function of temperature of the DSDs 102, 104. For example, the microprocessor 116 may determine adjustments to operating voltages based on one or more threshold temperatures. The applied adjustment may be based on a comparison of the current temperature information to the one or more threshold values. Such a formula or thresholds may be determined by the DSD manufacturer based on design information or based on test results generated during manufacturing testing. The formula and/or threshold information for a flash memory IC may be, for example, stored in memory locations within the flash memory IC. Some implementations may include a sensor to detect an ambient temperature within or external to a housing (not shown) that contains the system. Also, in some implementations, more than one temperature sensor may be used. For example, one or more temperature sensors may be located in, around, under, or between flash memory ICs 102 and/or the disc drive 104. Some flash memory ICs, for example, may provide an internal junction type or other thermal sensor that may be monitored. The microprocessor 116 may select an operating voltage stored in the register 122 of the flash memory 102. Then, the microprocessor may check the ambient temperature of the flash memory 102 based on measurements from the internal thermal sensors 124 and/or a thermal sensor 126. Using the predefined formula, the microprocessor 116 may adjust the selected operating voltage based on the received temperature information.

The microprocessor 102 may communicate with a non-volatile memory 128. The non-volatile memory (NVM) 128 stores a startup code 130, an operation code 132, and voltage information 134, including operating voltages for the flash memory 102 and the disc drive 104. The microprocessor 116 executes the startup code 130 to start up the DSD 102, 104. For example, the startup code 130 may include code that checks the register 122 for minimum operating voltages and current operating status, checks the thermal sensors 124, 126 for the ambient temperature of the DSD 102, 104, and calculates an adjusted voltage level based on received temperature information. During operation, in some implementations, the microprocessor 116 may execute the operation code 132. The operation code 132 may include code to maintain operation of the DSDs 102, 104 by dynamically updating the applied operating voltage based, for example, on performance of the DSDs 102, 104. After selection, the microprocessor 102 can store the selected operating voltages in the NVM 124. The voltage information 134 may include the selected operating voltage for the flash memory 102 and/or the disc drive 104.

The microprocessor 116 can exchange data with an external device (not shown) through a data interface 136. Data being transferred between the data interface 136 and the microprocessor 116 may be stored temporarily in a buffer 138. The operating mode of the data interface 136 may affect the selection of the operating voltage. For example, if the data interface 136 is receiving data from an external source in a time critical operation, the microprocessor 116 may minimize startup time by employing a looser selection scheme, for example, by using a bigger step size to increment the currently applied voltage. As another example, if the system 100 is operating as a portable device receiving data for the flash memory 102, then the microprocessor 102 may preserve battery life by employing a tighter selection scheme, for example, by using smaller step size to increment the currently applied voltage.

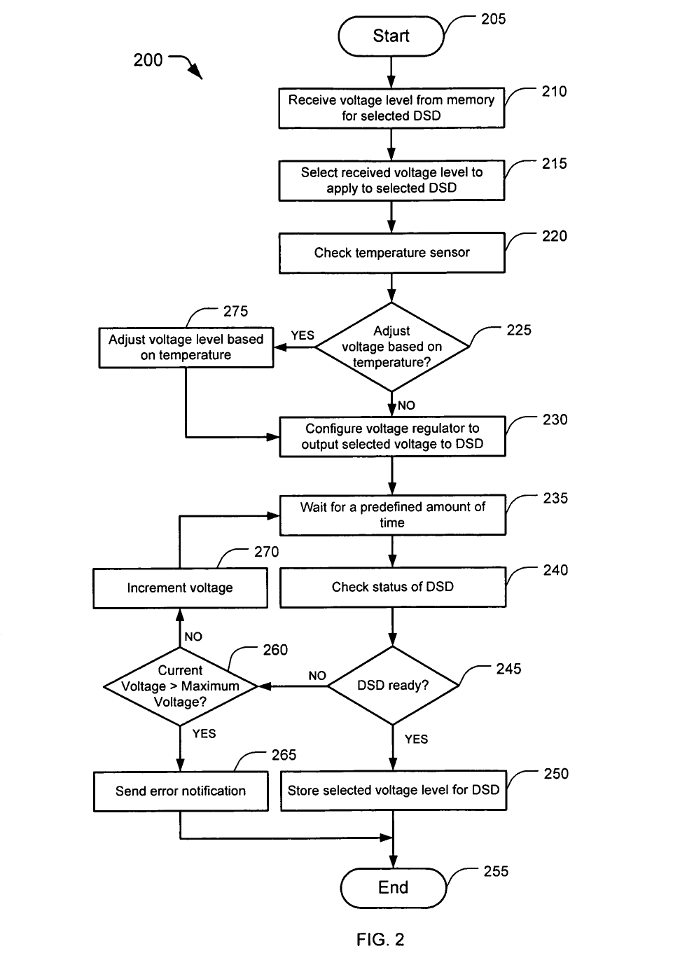

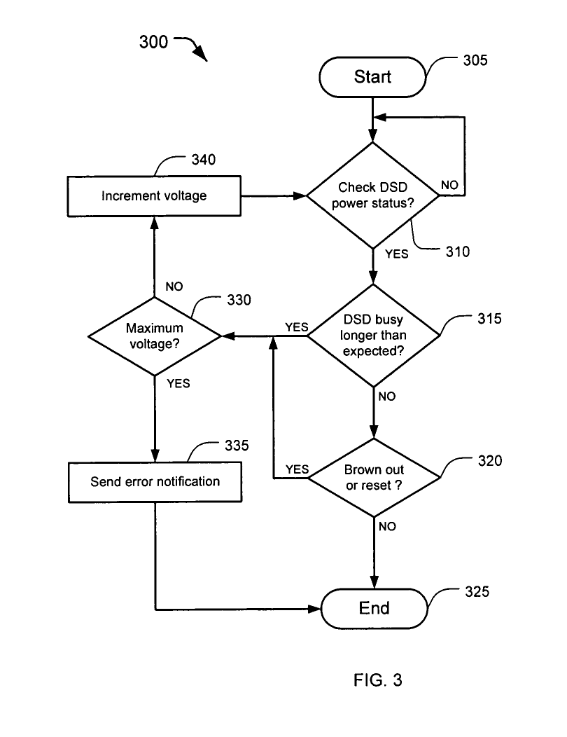

The microprocessor 116 may execute a program of instructions, such as the startup code 130 or the operation code 132, according to various methods, examples of which are described with reference to FIGS. 2-3, respectively.

In FIG. 2, a flowchart 200 illustrates an example of operations that the microprocessor 116 may perform when executing implementations of the startup code 130. Although the example illustrated in FIG. 1 shows a single block of the startup code 130 stored in the NVM 128 for execution by the microprocessor 116, other processors or logic may perform some or all of the operations, and may use instructions that are stored in locations other than in the NVM 128, such as in a RAM (not shown).

In this example, the method begins at step 205 when the microprocessor 116 receives a request to apply power to a selected DSD. For example, the microprocessor 116 may receive a read command for retrieving data from the flash memory 102. Next, in step 210, the microprocessor 116 may receive voltage level information from memory for the selected DSD. For example, the microprocessor may obtain the voltage level from the register 122 in the DSDs 102, 104, or the microprocessor 116 may obtain the voltage level from the voltage level information 134 stored in the NVM 128. The microprocessor may then, in step 215, select the received voltage to be applied to the selected DSD.

In step 220 of this example, the microprocessor 116 may check the temperature sensors, such as the internal temperature sensor 124 and/or the external sensor 126. Next, in step 225, the microprocessor 116 determines whether to adjust the selected voltage level based on temperature. In step 225, if an adjustment based on temperature is necessary, then the microprocessor 116 adjusts the voltage level based on temperature in step 275. After that, or if an adjustment based on temperature is not necessary at step 225, then the microprocessor 116 configures the voltage regulator 126 in step 230 to output the received voltage to the selected DSD. In step 235, the microprocessor 116 waits for a predefined amount of time before checking the status of the selected DSD in step 240. For example, the microprocessor may check the status by reading the register 122. In step 245, the microprocessor determines whether the DSD is ready. If, in step 245, the DSD is ready, then the microprocessor 116 may store the selected voltage level for the selected DSD in, for example, the NVM 128 and the method ends at step 255.

In step 245, if the selected DSD is not ready, then the microprocessor 116 determines whether the selected voltage is greater than a maximum voltage in step 260. A maximum voltage for outputs 112 or 114 may be limited, for example, by a maximum output voltage or current limit of the regulator 126, a maximum permitted input voltage to the DSD 102 or 104, and/or safe operating area limits of other circuitry operatively coupled to the corresponding voltage regulator output. If, in step 260, the selected voltage is not greater than the maximum voltage, then, in step 270, the microprocessor 116 may increment the currently selected voltage and the method repeats step 235.

If the selected voltage is greater than the maximum voltage, then, in step 265, the microprocessor 116 sends an error notification to indicate an error in operation of the selected DSD, and the method ends at step 255.

In FIG. 3, a flowchart 300 illustrates an example of operations that the microprocessor 116 may perform when executing implementations of the operation code 132. The microprocessor 116 may execute the operation code 132 to update the selected voltage level based on current performance. In this example, the method begins at step 305 when the microprocessor 116 is initiated, either during a memory access operation or during a periodic maintenance operation. In step 310, the microprocessor 116 may determine whether it should check the power status of the DSD. If no check of the power status of the DSD is necessary, the method 300 may return to step 310.

If, in step 310, a check of the power status of the DSD is necessary, then the microprocessor 116 may check whether the DSD is busy longer than expected at step 315. If the DSD is not busy longer than expected, then the microprocessor 116 may check whether there is a brown out or reset on the DSD in step 320. If there is no brown out or reset on the DSD, then the method ends at step 325.

If the DSD is busy longer than expected in step 315, or if a brown out or reset is detected in step 320, then the microprocessor may check whether the selected voltage is greater than a maximum voltage in step 330. A maximum voltage for outputs 112 or 114 may be limited, for example, by a maximum output voltage or current limit of the regulator 126, a maximum permitted input voltage to the DSD 102 or 104, and/or safe operating area limits of other circuitry operatively coupled to the corresponding voltage regulator output. If, in step 330, the selected voltage is not greater than the maximum voltage, then the microprocessor 116 increments the selected voltage in step 340, and the method repeats step 310. If, in step 330, the selected voltage is greater than the maximum voltage, then, in step 335, the microprocessor 116 sends an error notification to indicate an error in operation of the selected DSD, and the method ends at step 325.

By way of example and not limitation, various implementations may be applied in applications for which power management and/or long service life are important. In a power supply system of a product with a disc drive, for example, the voltage output of a low dropout regulator may be adjusted to enable access to a disc drive and/or a flash memory device as the operational power requirements for the DSD change. The operational power required to operate a disc drive, for example, may change due to wearing or contamination of the bearings that may increase static and/or dynamic friction at start-up and/or during operation, respectively. Friction may cause performance to deteriorate. To avoid the deterioration from causing a sudden failure, the voltage supplied to the drive may be incremented whenever the drive fails to meet one or more performance criteria. With a mechanism to incrementally increase the voltage supplied to the disc drive, a relatively low voltage may be initially selected to operate the drive. As the drive requires higher voltage to meet performance criteria, the voltage may be automatically incremented.

In some implementations, the system 100 may perform operations to indicate the present and/or past occurrence of conditions that cause the voltage level to be incremented. For example, user notification may be made via a user interface on a display (not shown), by an audible indicator (not shown), and/or by communications with a host though the data interface 136. In one example, the user may be notified of a possible impending failure of one or more DSDs if the voltage is increased because the DSD is busier longer than expected. The notification may take the form of a warning beep, a flashing icon, a colored indicator on a display, a status message, an email, and/or other electronic message to a specified email account.

Disc drive deterioration that leads to increased power supply requirements may occur under various conditions. Disc drive performance may deteriorate, for example, due to operational inefficiencies related to changes in bearing friction, air resistance, windage, source impedance, head-media impacts, humidity, contamination, or any combination thereof. Such operational inefficiencies may increase the minimum operating voltage for the disc drive. By increasing the output voltage supplied to the disc drive, data stored on the disc drive may be retrieved and/or the operational lifetime of the disc drive can be extended.

Flash memory deterioration that leads to increased power supply requirements may occur under various conditions. Flash memory performance may deteriorate, for example, due to operational inefficiencies related to flash cell degradation and/or impedance changes. Such operational inefficiencies may increase the minimum operating voltage for the flash memory. By increasing the output voltage supplied to the flash memory, data stored on the flash memory may be retrieved and/or the operational lifetime of the flash memory may be extended.

Although an example of a system, which may be portable, has been described with reference to FIG. 1, other implementations may be deployed in other processing applications, such as desktop and networked environments.

Some systems may be implemented as a computer system that can be used with implementations of the invention. For example, various implementations may include digital and/or analog circuitry, computer hardware, firmware, software, or combinations thereof. Apparatus can be implemented in a computer program product tangibly embodied in an information carrier, e.g., in a machine-readable storage device or in a propagated signal, for execution by a programmable processor; and methods can be performed by a programmable processor executing a program of instructions to perform functions of the invention by operating on input data and generating an output. The invention can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic discs, such as internal hard discs and removable discs; magneto-optical discs; and optical discs. Storage devices suitable for tangibly embodying computer program instructions and data include all forms of non-volatile memory, including, by way of example, semiconductor memory devices, such as EPROM, EEPROM, and flash memory devices; magnetic discs, such as internal hard discs and removable discs; magneto-optical discs; and, CD-ROM and DVD-ROM discs. The processor and the memory can be supplemented by, or incorporated in, ASICs (application-specific integrated circuits).

In some implementations, each system 100 may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. The invention may be implemented in a computer system that includes a graphical user interface and/or an Internet browser. To provide for interaction with a user, some implementations may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various implementations, the system 100 may communicate using suitable communication methods, equipment, and techniques. For example, the system 100 may communicate with compatible devices (e.g., devices capable of transferring data to and/or from the system 100) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

A number of implementations of the invention have been described. Nevertheless, it will be understood that various modifications may be made without departing from the spirit and scope of the invention. For example, advantageous results may be achieved if the steps of the disclosed techniques were performed in a different sequence, if components in the disclosed systems were combined in a different manner, or if the components were replaced or supplemented by other components. The functions and processes (including algorithms) may be performed in hardware, software, or a combination thereof, and some implementations may be performed on modules or hardware not identical to those described. Accordingly, other implementations are within the scope of the following claims.

What is claimed is:

1. A system with a data storage device, the system comprising:
a controllable voltage regulator having an output node regulated to a selected voltage;
a data storage device having an input to draw operating power from the voltage regulator output; and,
a processor to receive instructions that, when executed, cause the processor to perform operations to adjust the selected voltage at the voltage regulator output node, the operations comprising:
increasing the selected voltage if the data storage device fails to perform within an operating specification.

2. The system of claim 1, the operations further comprising determining whether the data storage device performs within the operating specification.

3. The system of claim 2, wherein determining whether the data storage device performs within the operating specification comprises checking the data storage device for a signal that indicates an insufficient power level condition in the data storage device.

4. The system of claim 2, wherein determining whether the data storage device currently performs within the operating specification comprises determining whether the data storage device has been busy longer than an expected time.

5. The system of claim 1, wherein the operating specification comprises the data storage device becoming ready to process a command within a predetermined period of time.

6. The system of claim 5, wherein the predetermined period of time occurs during a start-up cycle after a substantially unpowered state.

7. The system of claim 5, wherein the predetermined period of time comprises a time immediately after the data storage device begins to process a memory access request.

8. The system of claim 1, wherein the data storage device comprises at least one flash memory device.

9. The system of claim 1, wherein the data storage device comprises a rotating storage medium.

10. The system of claim 1, wherein the data storage device comprises a hard disc drive.

11. The system of claim 1, further comprising operations to measure at least one temperature and adjust the received information based upon the at least one temperature measurement.

12. A method of applying power to a data storage device, the method comprising:
identifying a voltage to operate a data storage device;
supplying the identified voltage to the data storage device;
determining whether the data storage device operations meet at least one performance criterion; and
controlling the voltage regulator to increment the voltage supplied to the data storage device.

13. The method of claim 12, wherein the data storage device comprises flash memory.

14. The method of claim 12, wherein the data storage device comprises a rotating storage medium.

15. The method of claim 12, wherein the data storage device comprises a hard disc drive.

16. The method of claim 12, further comprising measuring at least one temperature and adjusting the identified voltage based upon the at least one temperature measurement.

17. The method of claim 12, wherein the performance criterion comprises the data storage device becoming ready to process a command within a predetermined period of time.

18. The method of claim 17, wherein the predetermined period of time comprises a period of time after the voltage regulator supplies the voltage to the data storage device.

19. The method of claim 12, further comprising repeatedly determining whether the data storage device operations meet at least one performance criterion and controlling the voltage regulator to increment the voltage supplied to the data storage device until the data storage device operations meet the at least one performance criterion.

20. The method of claim 12, further comprising receiving a request to apply power to the data storage device in an unpowered state.

21. An article of manufacture comprising machine-readable instructions that, when executed, cause operations to be performed, the operations comprising:
receiving information indicative of a voltage level to apply to a data storage device in an unpowered state;
controlling a voltage regulator to supply a voltage to the data storage device at the voltage level indicated by the received information;
determining whether the data storage device operations meet at least one performance criterion; and
controlling the voltage regulator to increment the voltage supplied to the data storage device.

22. The article of claim 21, wherein the data storage device comprises a member of the group consisting of: at least one flash memory device; a rotating storage medium; and, a hard disc drive.

23. The article of claim 21, further comprising repeatedly determining whether the data storage device operations meet at least one performance criterion and controlling the voltage regulator to increment the voltage supplied to the data storage device until the data storage device operations meet the at least one performance criterion.

24. The article of claim 21, the operations further comprising adjusting the received information based upon at least one temperature measurement.

25. An apparatus comprising:
a controllable voltage regulator having an output node regulated to a selected voltage;
a data storage device having an input to draw operating power from the voltage regulator output node; and,
means for incrementing the selected voltage if the data storage device fails to perform within an operating specification.

26. The apparatus of claim 25, wherein the incrementing means comprises means for determining whether the data storage device operations meet at least one performance criterion.
